(19) United States
(12) Patent Application Publication
(10) Pub. No.: US 2003/0110501 A1
(43) Pub. Date: Jun. 12, 2003

(54) Personalizing media presentations based on a target duration

(76) Inventors: Richter A. Rafey, Santa Clara, CA (US); Klaus Hofrichter, Santa Clara, CA (US); Jerrold Godes, Brookdale, CA (US)

Correspondence Address: Maria McCormack Sobrino, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/020,049

(22) Filed: Dec. 12, 2001

(51) Int. Cl. H04N 7/16; H04H 9/00; G06F 3/00; H04N 5/445; G06F 13/00

(52) U.S. Cl. 725/46; 725/44; 725/47; 725/9

(57) ABSTRACT

A method and system for personalizing media presentations based on a target duration is disclosed. The process includes assembling content for viewing based upon a specified duration.

### FIELD OF THE INVENTION

The invention relates generally to the personalization of media presentations. More specifically the invention relates to the personalization of media programming based on a target duration.

### BACKGROUND

Personal Video Recorders have ushered in a new era of television programming where local disk storage of broadcast content is going to become increasingly prevalent in consumer settings. By coupling this local storage capacity with metadata that structures the content, a consumer has the capacity to restructure the content for different types of presentation, with segments of video being used as building blocks.

In one example, custom news is offered as clips on a web site, where the news clip presentation is based on viewer preferences. One of the preferences that a viewer can set is the number of stories (e.g., 6, 12 or 18). However, using such a system, it is not easy to accommodate a viewer's time budget since news stories are of varying length. What is needed is a system that provides a continuous, passive screen presentation. Using the system, viewers are expected to launch each clip individually and then view them on a web browser. Other systems offer a similar customized video system for use on PC desktops. The customized content may be communicated to a television set top box. However, this system does not facilitate the restructuring of broadcast programs according to user-specified duration constraints.

### SUMMARY OF THE INVENTION

A method and system for personalizing media presentations based on a target duration is disclosed. The process includes assembling content for viewing based upon a specified duration.

### BRIEF DESCRIPTION OF THE DRAWINGS

The present invention is illustrated by way of example and not limitation in the figures of the accompanying drawings, in which like references indicate similar elements and in which:

FIG. 1 shows one embodiment of the system architecture of the present invention.

FIG. 2 shows one embodiment of an exemplary presentation manager.

FIG. 3 depicts an exemplary processing system with which the content rearranging processes may be implemented.

FIG. 4 shows an exemplary process used by the system user to specify a programming content time budget according to one embodiment of the present invention.

### DETAILED DESCRIPTION

The system and method of the present invention allows viewers to leverage a platform having a sophisticated presentation system to adjust and focus program coverage for storage and viewing. In one embodiment, a viewer simply specifies a time budget for the program, and the system arranges content to be stored or viewed based upon the time budget. For example, viewing may be provided of portions of particular content up to the time budget. Furthermore, in one embodiment, the content can be divided into segments, each having associated time duration, content description and viewer priority information such that the content based on priorities (and possibly user preferences) are to fit within that time budget. One example would be to enable a viewer to specify viewing a 15-minute version of an hour-long news broadcast. The viewer may set this as an enduring preference, or may simply specify the preference when selecting the program. The viewer may then watch the content with no further interaction. Further interaction isn't precluded, but in one embodiment the new program is structured to fit within the viewer-specified duration assuming passive viewing.

Descriptive data may be associated with the content and may be used to arrange content according to user preferences and/or priorities. In one embodiment, metadata associated with programs and describing the semantics and duration of the various segments are referenced to define segments of content and order of segments for viewing. In one embodiment, a list of segments of content may be encoded as pointers to in and out points of segments that form a story that make up a play list for presentations, including variable length presentations. Alternatively, multiple versions of the same content, differing in length are communicated. For example, 30 seconds, 1 minute and 2 minute segments of a program may be communicated. The specified time budget then indicates the segment of the program to use. The portions may be communicated via a variety of media including portions of the DTV spectrum or via broadband Internet. In this embodiment, metadata is used to identify common subject content of varying lengths.

In one embodiment, the present invention processes descriptive data, such as metadata, to reorganize the content within with an emphasis on duration of the segments, further refined by priorities and the user preference. Priorities may be set by the content providers: for example, the editorial staff of a news program may prioritize the news stories that compose a news program. Priorities and preferences may be set by a user to tailor program viewing.

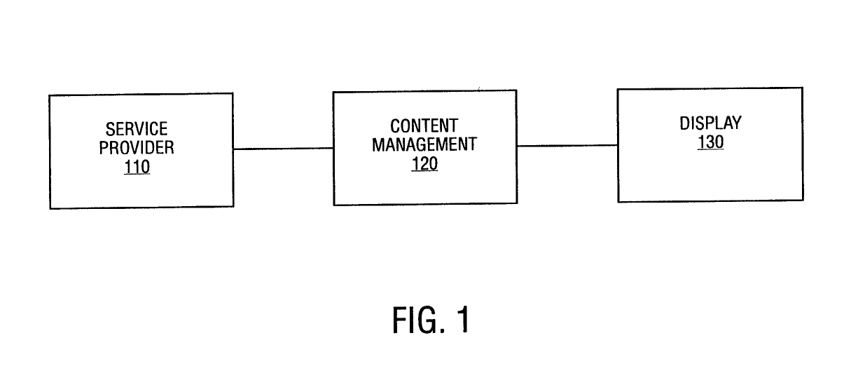

FIG. 1 is a simplified block diagram illustrating one embodiment of the system architecture of the present invention. FIG. 1 shows service provider 110, content manager 120, and display 130.

The service provider 110 transmits viewer services into an environment such as the home environment. Communication can be made across a variety of means, static and dynamic, including broadcast and broadband, cable, satellite, terrestrial, digital video (DVD), Internet and the like. The communication may consist of content alone or with data, such as data describing the content. In one embodiment the descriptions of content are embodied in metadata. The metadata may include a variety of data including time-duration of the entire content, segments of the content, input and output points of a data stream delineating segments, and descriptions of content segments.

Content Manager 120 manages the content for display on display 130. Alternately, the content of interest is stored in a storage device (not shown) for later access by the user, for example, for later display on device 130. The content manager includes the functionality to sort and filter content in accordance with the teachings provided herein. The content manager 120 may be located at the service provider, controlled at least in part by the service provider 110, located at the user's environment, e.g. in a set top computer and the like or at the display. The content manager 120 may also be a separately operatable device coupled to the service provider 110 and display 130.

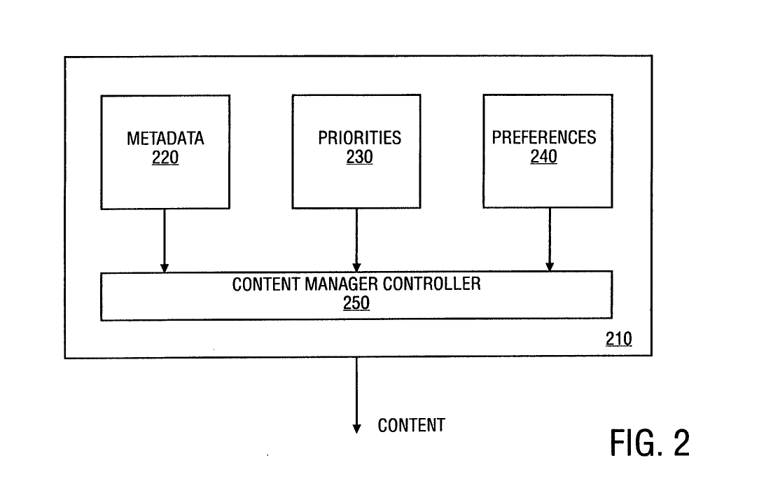

FIG. 2 functionally illustrates one embodiment of an exemplary content manager 210. The content manager 210 includes a metadata block 220, priorities block 230 and preferences block 240.

Metadata block 220 analyzes incoming data providing information needed to select and sort content according to the user specified time budget. In one embodiment the descriptive data is transmitted via a broadcast signal of the corresponding content. In one embodiment, the descriptive data is metadata. The metadata may include both descriptive portions and other information related to the transmitted content. In one embodiment, the transmissions also includes fine-grain metadata that describes the semantics and duration of the various segments of content.

Metadata block 220 processes the received descriptive data and directs the reorganization of the programming content according to the user specified time budget. For example, segments of content are filtered to include an appropriate mix of segments less than or equal to the user specified time budget. Alternately, those segments that fit within the time budget are organized ahead in viewing sequence of those that would extend beyond the time budget. Still alternately, content may be clipped to meet time budget constraints. This reorganization places an emphasis on the duration of the segments.

The priority block 230 analyzes priorities of content. These priorities may be set in the metadata by the editorial staffs employed by the providers of content. For example, priority of newsworthiness of stories that compose a news broadcast may be identified. Other priorities may be provided by user preferences. The priorities may be used to further sort the content. Preference block 240 contains or receives user preferences of content. For example, the user may specify a preference for sports. Segments of the news broadcast that fit within the user specified time budget and relevant to sports would be provided first. The user preferences may be implicitly or explicitly derived. In one embodiment, the user preferences are implicitly derived by analyzing usage patterns of users. Explicit preferences are those explicitly requested or specified, typically by the user.

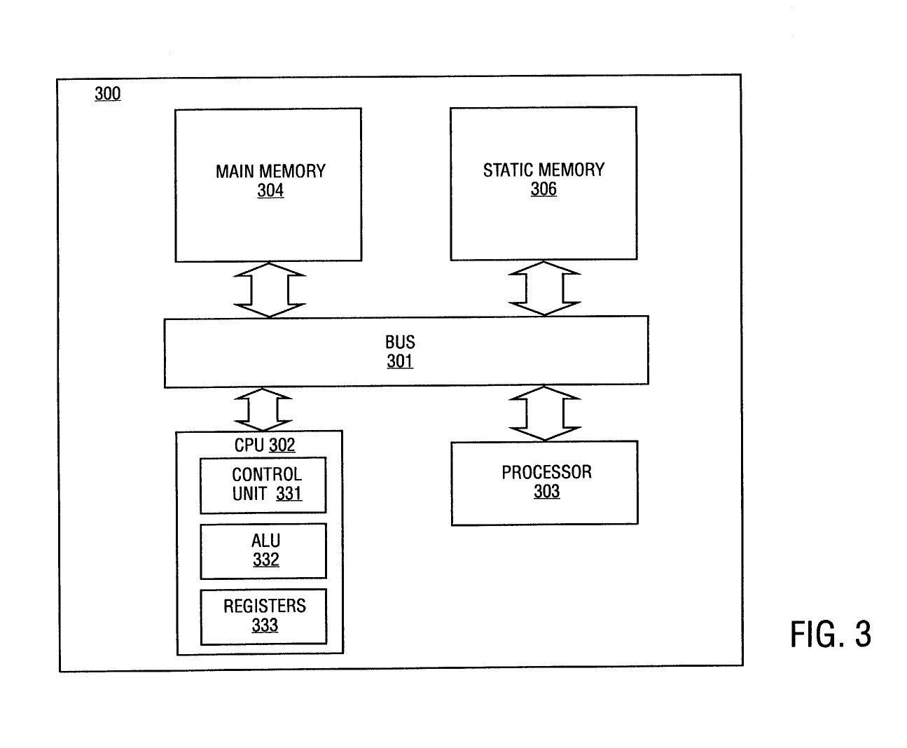

Content management controller 250 manages the content that is eventually presented to the system user using information provided by metadata block 220, priorities block 230, and preferences block 240. For example, the content management controller 250 processes the descriptive data to reorganize the content with an emphasis on duration of the segments, further refined by priorities set in the descriptive data, and from user preferences. It is recognized the FIG. 2 functionality describes the system and can be physically configured as a variety of logic and systems including processing systems, such as illustrated by FIG. 3.

FIG. 3 depicts an exemplary processing system 300 with which the content rearranging processes may be implemented. In one embodiment, the programming content rearranging process may be implemented based on a general processing architecture. Referring to FIG. 3, digital processing system 300 includes a bus 301 or other communications means for communicating information, and central processing unit (CPU) 302 coupled with the bus 301 for processing information. CPU 302 includes a control unit 331, an arithmetic logic unit (ALU) 332 and several registers 333. For example, registers 333 may include predicate registers, spill and fill registers, loading point registers, integer registers, general registers and other like registers. CPU 302 can be used to implement the programming content rearranging processes described herein. Furthermore, another processor 303 such as, for example a coprocessor can be coupled to bus 301 for additional processing power and speed.

Signal processing system 300 also includes a main memory 304, which may be a random access memory (RAM) or some other dynamic storage device that is coupled to bus 301. Main memory 304 may store information and instructions to be executed by CPU 302. Main memory 304 may also store temporary variables or other intermediate information during execution of instructions by CPU 302. Digital processing system 300 may also include a static memory 306 such as, for example, a read only memory (ROM) and/or other static source device that is coupled to bus 301 for storing static information and instructions for CPU 302. A mass storage device 307, which may be a hard or floppy disk drive, can also be coupled to bus 301 for storing information and instructions.

In addition, the methods as described above can be stored in a computer system as a set of instructions to be executed. The instructions to perform the methods as described above could alternatively be stored on other forms of computer readable mediums, including magnetic and optical disks. For example, the method of the present invention can be stored on computer readable mediums such as magnetic disks or optical disks that are accessible via a disk drive (or computer-readable medium drive).

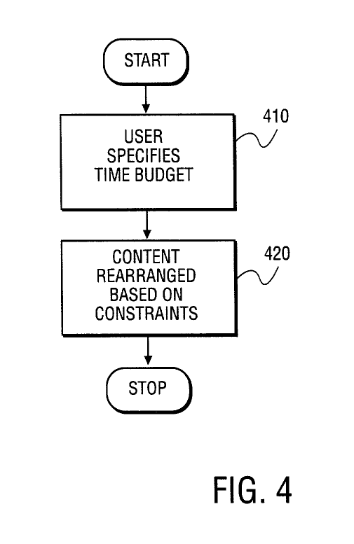

FIG. 4 shows an exemplary process of the present invention. At step 410, the user specified time budget is accessed. This may be specified each time the system is used or a time budget value may be stored for access and changed only when desirable. The time budget constraint may be transmitted to the system via wired, wireless or optical means. For example, the system may include a graphical user interface on the display or a simple manual (e.g. dial or button) on a control apparatus. The time budget determines the rearrangement of programming content.

At step 420, the content is rearranged based on the time budget specified by the user. As noted earlier, descriptive information, such as metadata may be used to identify segments and corresponding durations.

In one embodiment, content is arranged from shortest in duration to longest in duration, the longest not exceeding the user time budget. In alternate embodiments, content is further arranged according to priorities and/or user preferences.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising arranging content for viewing based upon a user specified duration.

2. The method as set forth in claim 1, wherein arranging further comprises selecting content based upon content preferences and providing selected content for no more than the user specified duration.

3. The method as set forth in claim 2, wherein providing is selected from the group consisting of presenting the arranged content to the user and storing the arranged content.

4. The method as set forth in claim 2, wherein the content preferences are selected from the group consisting of preferences set by an editorial staff and preferences set by the user.

5. The method as set forth in claim 4, wherein the content further comprises data enabling selection of content based upon content and preferences.

6. The method as set forth in claim 2, wherein the content preferences selected from the group consisting of explicitly developed user preferences and implicitly developed preferences based upon at least one user's usage.

7. A method comprising:
specifying a time budget for recording a program; and
arranging content based upon priorities to fit within the time budget.

8. The method as set forth in claim 7, further comprising storing arranged content.

9. The method as set forth in claim 8, wherein priorities are selected from the group consisting of user preferences and priorities of content providers.

10. A method comprising:
receiving content and associated data indicating content segment locations, descriptions and duration; and
arranging selected content in accordance with a time budget, the content selected determined using content segment location, descriptions and duration.

11. The method as set forth in claim 10 wherein receiving comprises receiving multiple versions of content of varying lengths, the arranging selecting a version of content within the time budget.

12. The method as set forth in claim 10 wherein the descriptions comprise descriptions of the content and the content segment locations comprises segment locations of corresponding descriptions.

13. The method as set forth in claim 10, wherein arranging further comprises reorganizing according the time budget and priorities provided in segment descriptions.

14. An apparatus configured to arrange viewing content based upon a user specified time duration.

15. The apparatus as set forth in claim 14, wherein time duration of at least a portion of the content is indicated by data associated with the content, said apparatus further configured to identify time durations of segments of content and arrange the content using identified time durations of segments.

16. The apparatus as set forth in claim 15, further configured to refine arrangement of content according to preferences.

17. The apparatus as set forth in claim 15, wherein the data comprises metadata.

18. The apparatus as set forth in claim 17, further configured to analyze user preferences, priorities, and time duration of segments and arrange content based upon user preferences, priorities and time duration.

19. The apparatus as set forth in claim 14, wherein the apparatus is located at one of a service provider, local to the storage device to store arranged data, remote from the storage device to store arranged data, local to the viewing device to view arranged content.
